(19) United States
(12) Patent Application Publication
(10) Pub. No.: US 2024/0253314 A1
(43) Pub. Date: Aug. 1, 2024

(54) METHOD OF AND ASSEMBLY FOR PRODUCING A FIBER PREFORM OR MANUFACTURING A COMPOSITE COMPONENT

(71) Applicant: Airbus Operations GmbH, Hamburg (DE)

(72) Inventors: Benjamin Teich, Stade (DE); Ali Yildiz, Stade (DE); Roman Kleinpeter, Stade (DE); Anja Häberle, Hamburg (DE); Johannes Stolz, Hamburg (DE); Thomas Küther, Dornbusch (DE)

(21) Appl. No.: 18/425,326

(22) Filed: Jan. 29, 2024

(30) Foreign Application Priority Data
Jan. 31, 2023 (EP) 23154349.7

(51) Int. Cl. B29C 70/44; B29C 70/54

(52) U.S. Cl. CPC B29C 70/44; B29C 70/544

(57) ABSTRACT

A method which may serve to producing a fiber preform for a fiber reinforced composite component and/or to manufacturing the fiber reinforced composite component. The method includes pressing an evacuable envelope enclosing a fiber preform material against a forming tool, the pressing being accomplished by evacuating an evacuable bag containing the evacuable envelope with the fiber preform material. The method further includes heating the forming tool and/or the preform, evacuating the envelope, and unsealing the bag while maintaining the envelope evacuated. Due to the maintained evacuated state, a clamping force acts on the fiber preform material which force serves to compensate different shrinkage of the forming tool and the fiber preform material when both cool down. It allows removing the evacuable envelope with the fiber preform material at any temperature after forming. Also, an assembly is disclosed to carry out the method.

### TECHNICAL FIELD

The disclosure herein concerns a method of and an assembly which may serve to producing a fiber preform for a fiber reinforced composite component and/or to manufacturing a fiber reinforced composite component.

### BACKGROUND

Fiber reinforced composite components are employed and appreciated for numerous applications. In particular, they provide benefits in the field of lightweight construction of structures such as vehicles, in particular aircrafts, sports equipment or wind turbines, for instance.

To fabricate such components, a fibrous preform is bonded with a matrix material. In particular, such preform may be a pre-preg made of fibers which are pre-impregnated by the matrix, which pre-preg may be molded into a desired shape and heated under pressure for curing. According to other procedures, the fibrous preform may be a dry fiber preform, i.e., made of a dry fiber material held together by a binder material, which dry fiber preform may be molded in the desired shape before being impregnated by the matrix.

In document EP 2 754 548 A1, a method for producing preforms for fiber reinforced composites is disclosed. According to this teaching, to built-up a three-dimensional laminar preform, layers of dry fibers are laid, between a first and a second thermoplastic or thermoset resin or foil layer, on a three-dimensional workpiece carrier. An air-tight packing of the fibers between the first and the second layer is produced and evacuated to stabilise the preform. The thus packed preform with its fibers and the first and second thermoplastic or thermoset resin or foil layers forms a unit which can be easily transported, stored and—in due course—cured in a hot-pressing device.

### SUMMARY

It is an object of the disclosure herein to provide a simplified alternative technique improving a manufacture of a fiber reinforced composite component.

The object is achieved by a method and by an assembly disclosed herein. Advantageous embodiments are disclosed in the description and the figures.

A method according to the disclosure herein comprises pressing an evacuable envelope enclosing a fiber preform material against a forming tool. The pressing is effected by evacuating an evacuable bag which contains the evacuable envelope with the fiber preform material enclosed therein.

The fiber preform material is configured to be used for manufacturing a fiber reinforced composite component. It may be a dry fiber preform material (i.e., a material comprising a structure of dry fibers and a binder holding them together) or a pre-preg (comprising fibers which are pre-impregnated by a matrix). It may comprise woven or non-woven fibers; in particular, it may include a mat of fibers, a fleece, a fabric, or a fiber stack such as a laminate of layers formed by various strands or portions of a common filament running in parallel. When the pressing is started, the fiber preform material may have a flat shape, from which it may preferably deviate during and due to the ongoing pressing.

The method according to the disclosure herein further comprises heating the forming tool and/or the fiber preform material, evacuating the evacuable envelope, and (thereafter) unsealing the bag (i.e., allowing air to flow to the envelope), while (contemporaneously) maintaining the envelope evacuated; the unsealing may comprise eliminating the bag's structure of forming a receptacle.

According to advantageous embodiments, the method may further comprise unsealing the evacuated envelope. If a dry fiber preform material is used as the fiber preform material, the thus produced fiber preform may be taken out of the envelope. The method may further comprise impregnating the fiber preform with a matrix.

Alternatively, as mentioned above, the fiber preform material may be a pre-preg. In this case, the method may serve to molding the pre-preg to be a fiber preform.

Additionally or alternatively, when the fiber preform material is a pre-preg, the heating may comprise heating the fiber preform material to a curing temperature of the pre-preg, preferably for a designated curing time. In this case, the method may thus comprise curing the pre-preg and, thereby, manufacturing a fiber reinforced composite component. Advantageously, such method further comprises tempering the cured pre-preg. Such embodiments in particular advantageously simplify the production of the fiber reinforced composite component, making curing tools dispensable.

Accordingly, the method according to the disclosure herein in particular may serve to producing a fiber preform having a predetermined shape for being used (possibly later on) in manufacturing a fiber reinforced composite component. Additionally or alternatively, the method may serve to manufacturing a fiber reinforced composite component.

The fiber reinforced component may in particular be a stiffener (in particular a stiffener designated for use in an aerospace application), for instance, in particular be a stringer such as a T-shaped stringer.

The pressing may preferably comprise pressing the evacuable envelope against an uneven surface the forming tool may preferably have, e.g., against a corner, against an edge and/or against a bulge of the forming tool. By way of the pressing, the fiber preform material enclosed in the evacuable envelope is forced to at least partially abutting on the forming tool, whereby the fiber preform material is molded. Indeed, the pressing preferably causes the fiber preform material to deform so as to have a three-dimensional structure which may comprise one or more inflection/s, curvature/s and/or corner/s. In particular, the forming tool provides a negative of a shape the fiber preform material is intended to be given in at least a portion thereof.

In particular, the disclosure herein thus employs two evacuable receptacles, namely the evacuable envelope and the evacuable bag. As is to be understood, the attribute “evacuable” refers to the bag being made of an air-tight material and being in an unevacuated state, i.e., containing air available for being extracted from the bag, such as by a vacuum pump or by a device configured to squeeze the bag. The same holds analogously for the envelope. Preferably, the bag and/or the envelope are/is at least partially made of a flexible material such as a membrane. Such (flexible) membrane may at least partially be made of a plastic foil or a metal foil, for example.

Accordingly, when the envelop or bag is being evacuated, respectively, air is being extracted therefrom, whereby a volume respectively enclosed by the envelope or bag is reduced; in particular, after the evacuating, the evacuated envelope or bag, respectively, is technically void of air (i.e., as feasible). The extracting may be effected by squeezing the respective receptacle (envelope or bag) and/or by connecting it to a vacuum pump.

The evacuating of the envelope may be effected by opening a sealing of the envelope while this is being pressed against the forming tool, such that air is forced out of the envelope due to the bag being evacuated. After its evacuation, the envelope may preferably be sealed again.

In particular, the evacuating of the envelope may form part of vacuum-packing the fiber preform material in the envelope. Additionally or alternatively, the evacuating of the bag may form part of vacuum-packing the envelope within the bag.

According to advantageous embodiments of the disclosure herein, the evacuable bag is built by at least a portion of the forming tool and a flexible membrane which covers the portion and is sealed with the portion and/or with a base the forming tool may be positioned on. For example, the flexible membrane may be sticked to the portion and/or base by an air-tight glue line.

In such embodiments, unsealing the bag may comprise at least partially detaching the membrane from the forming tool and/or the base (which may eliminate the bag's structure forming a receptacle).

According to alternative embodiments, the evacuable bag may be a receptacle containing not only the evacuable envelope with the fiber preform material, but also at least a portion of the forming tool. Such evacuable bag preferably is at least partially made of a flexible membrane.

By the heating the forming tool, also the fiber preform material within the envelope pressed against the forming tool is heated. The heating allows a movement of the fibers contained in the fiber preform material relative to each other. In particular, by the heating, the fiber preform material may preferably be warmed up to at least a melting temperature of a binder or matrix the fiber preform material may respectively contain as mentioned above. A cohesion of the fibers may thus be reduced or even eliminated. Accordingly, and as the air contained in the evacuable envelope buffers the pressure exerted thereon, a formation of the fibers in the fiber preform material changes. Due to such change, the fiber preform material evenly further adjusts to the shape of the forming tool.

When the envelope then is evacuated, the fiber preform material is compressed in its thus created form (and fiber formation). That is, a clamping (compacting) force is applied to the fiber preform material, which force inhibits or at least reduces the movability of the fibers within the fiber preform material's structure. Thereby, a subsequent (further) deformation of the fiber preform material is suppressed even when the pressing against the forming tool is released by unsealing the bag.

The releasing of the pressing, however, diminishes or even ceases the dependency of the fiber preform material's shape from the forming tool. Accordingly, when the heating is stopped and the forming tool cools down, the shape of the fiber preform material within the evacuated envelope is maintained even if its correspondence to the shape of the forming tool subsides due to different shrinkages resulting from different thermal expansion properties of the respective materials.

As a consequence, the unfavorable occurrence of undulations on a produced fiber preform and/or on a manufactured composite component can be reduced, whereby a quality of the preform and/or composite component is improved. Also, more complex geometries and meeting of tighter tolerances are facilitated by the method according to the disclosure herein.

Moreover, consideration of the respective thermal expansion properties of the materials of the forming tool with regard to the fiber preform material becomes less critical when choosing the forming tool for producing the fiber preform. In particular, a forming tool made of a material having other advantages (such as with regard to its accessibility and/or with respect to a manufacture and/or durability of the forming tool manufactured therefrom) can be used for producing the fiber preform and/or for manufacturing the composite component. Analogously, a flexibility in the selection of the fiber preform material is improved, especially with respect to binder and/or matrix materials contained therein.

Moreover, as the envelope encloses the fiber preform material, it runs around the fiber preform material, such that a portion of the envelope is arranged, during the pressing, between the fiber preform material and the forming tool. Accordingly, the envelope separates the fiber preform material from the forming tool during the pressure and thus inhibits direct contact of the fiber preform material with the forming tool. As a consequence, a cleaning of the forming tool after the production of the fiber preform and/or manufacture of the composite component becomes dispensable.

As is to be understood, some or all of the acts comprised by the method, in particular the acts of pressing, heating, evacuating the evacuable envelope, and unsealing the bag may be started and/or stopped successively or contemporaneously, and/or their execution may at least partially overlap. In particular, the envelope is preferably evacuated while (still) being pressed against the forming tool, in particular while the bag is in an evacuated state. Additionally or alternatively, the heating is preferably processed (started and/or continued) while the evacuable envelope containing the fiber preform material is being pressed against the forming tool, thus, when the bag is in an evacuated state, and/or the heating is stopped or at least reduced before the bag is unsealed.

The method according to the disclosure herein may comprise inserting the fiber preform material into the envelope. The inserting in this case may preferably be done before joining the evacuable envelope to the forming tool, i.e., when the envelope is still separate from the forming tool. This allows a particularly convenient provision of the envelope enclosing the fiber preform material.

According to advantageous embodiments, the method comprises letting the forming tool cool down, e.g., to a temperature ambient to the forming tool, and/or to a temperature of at most 80° C. or at most 60° C. In particular, the method may preferably comprise stopping the heating of the forming tool and/or of the fiber preform material. Such embodiments may further comprise (actively) cooling the forming tool and/or the fiber preform material by a cooling means such as a fan, a fluid system and/or a thermal pack.

Additionally or alternatively, the method according to the disclosure herein may comprise letting the forming tool and/or the fiber preform material cool down, and unsealing the evacuated envelope after the fiber preform material has reached a temperature exceeding an ambient temperature by at most 80° C. or at most 60° C. or at most 40° C. or at most 20° C., and/or after the fiber preform material has reached a temperature of at most 100° C. or at most 80° C. or at most 60° C. Accordingly, the envelope is not unsealed and the produced fiber preform or the manufactured composite component, respectively, is not taken off the envelope before it has cooled down at least to the (respective) temperature. Thereby an undesired supplementary deformation can be prevented.

Additionally or alternatively, the method according to the disclosure herein may comprise taking the (still) evacuated envelope off the forming tool when a temperature of the forming tool exceeds an ambient temperature thereof by at least 25° C. or at least 50° C. or even at least 80° C. The fiber preform material within the envelope may thus cool down separate from the forming tool. Thereby, a faster process time may be effected, and/or a cooling down or at least a complete cooling down of the forming tool may be avoided, such that a further fiber preform may be produced, using the still heated forming tool and thus with less consumption of energy.

Preferably, the ambient temperature (i.e., the temperature ambient to the forming tool) is at most 60° C. Additionally or alternatively, it may be at least 20° C., at least 40° C., or at least 50° C.

An assembly according to the disclosure herein comprises an envelope which is made of an air-tight material and adapted to receive a fiber preform material, preferably along with extractable (excess) air, so as to be evacuable. In particular, the envelope is preferably adapted to be evacuable when enclosing the fiber preform material. Advantageously, the envelope is further adapted to be sealed.

Moreover, the assembly comprises a forming tool configured to giving the fiber preform material a predetermined shape. Therein, the forming tool is heatable. For example, it may comprise at least one heating element such as one or more resistance wire/s, and/or it may be configured to be connected to a heater for adopting heat therefrom, such as by comprising a lead system for channeling a fluid heated be the heater.

The assembly further comprises a bag component. Such bag component may be adapted to contribute to forming an evacuable bag adapted to accommodate the envelope with the fiber preform (and—possibly—extractable air) contained therein. For instance, such bag component may comprise an air-tight membrane adapted to be sealed to the forming tool and/or—if applicable—to a base the forming tool may be positioned on, thereby forming the evacuable bag in conjunction with the forming tool and/or the base. Alternatively, the bag component may itself form an evacuable bag adapted to contain the envelope with the fiber preform (and—possibly—extractable air) contained therein. In such case, the evacuable bag is preferably further adapted to contain at least a portion of the forming tool. In both cases, the evacuable bag formed by the bag component (alone or in conjunction with the forming tool and/or the base) then is adapted to effect that the envelope enclosing the fiber preform material is pressed against the forming tool when the evacuable bag is evacuated.

A device for evacuating the evacuable bag is further comprised by the assembly according to the disclosure herein, which may comprise a vacuum pump and/or a pressurising device and/or at least one valve.

In particular, the assembly according to the disclosure herein is preferably adapted to be used for carrying out a method according to an embodiment of the disclosure herein. It may serve for producing a fiber preform to be used (possibly later on) in manufacturing a fiber reinforced composite component, and/or for manufacturing a fiber reinforced composite component. Reversely, the method according to the disclosure herein is preferably carried out by an assembly according to an embodiment of the disclosure herein.

According to advantageous embodiments, the forming tool is at least partially made of one or more metal/s. It may comprise at least one separating film and/or a coating which during the pressing is arranged between a mold portion of the forming tool and the evacuable envelope.

### BRIEF DESCRIPTION OF THE DRAWINGS

In what follows, preferred embodiments of the disclosure herein are explained with respect to the accompanying drawings. As is to be understood, the various elements, components and geometrical structures are depicted as examples only, may be facultative and/or combined on a manner different than depicted. Reference signs for related elements are used comprehensively and not defined again for each figure.

Shown is schematically in:

FIGS. 1a-1d: an assembly according to an example embodiment of the disclosure herein while carrying out an example method according to the disclosure herein.

### DETAILED DESCRIPTION

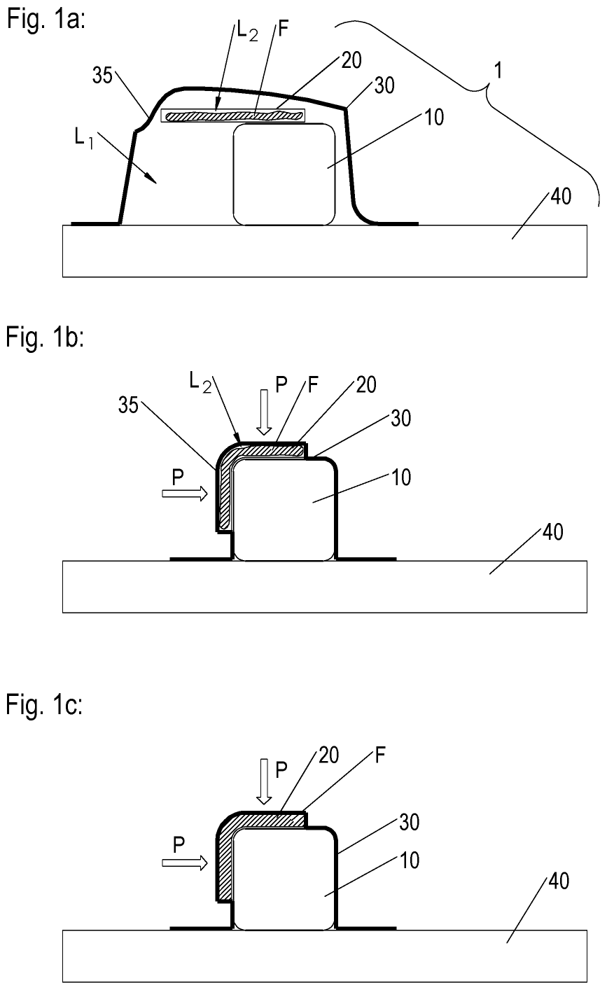

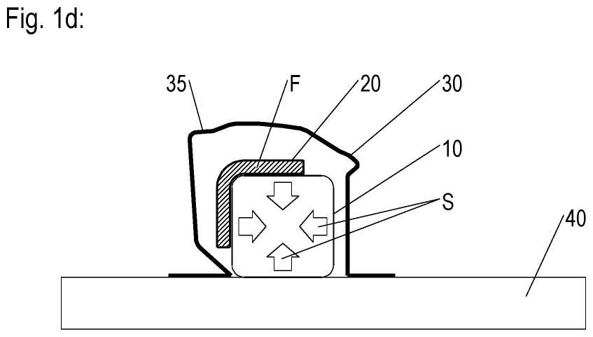

FIGS. 1a-1d illustrate, by a sectional view, the processing of a method according to an embodiment of the disclosure herein with an assembly 1 according to an example embodiment of the disclosure herein. The assembly 1 comprises a base 40, a heatable forming tool 10 positioned on the base 40, and an envelope 20 made of an air-tight material, which in the situation depicted in FIG. 1a encloses not only a fiber preform material F, but also air L₂ which is available for extraction from the envelope 20. In particular, in the state shown in FIG. 1a, the envelope 20 is thus evacuable. The fiber preform material F may be a pre-preg or a dry fiber preform material whose dry fibers are kept together by a binder.

The assembly 1 further comprises a bag component 30 which in the present case is configured as a flexible membrane made of an air-tight material. As can be seen in FIG. 1a, the bag component 30 is configured to contribute to forming an evacuable bag 35 adapted to accommodate the evacuable envelope 20 with the fiber preform F contained therein: Indeed, in the figure, the flexible membrane 30 is seen to be sealed to the basis 40. Thereby, the bag component 30 forms, in conjunction with the forming tool 10 and the base 40, the bag 35 accommodating the evacuable envelope 20 with the fiber preform material F contained therein.

In the situation illustrated in FIG. 1a, the bag 35 further contains air L₁ which is available for extraction, whence in the state, the bag 30 is evacuable.

FIG. 1b illustrates a state in which the air L₁ has been extracted from the bag 35 using a device such as a vacuum pump (not shown in the figures) further comprised by the assembly. The bag 35 is thus evacuated, whereby the evacuable envelope 20 with the fiber preform material F contained therein is pressed, with a pressure P, against the forming tool 10. In the example case shown, the evacuable envelope and, therewith, the fiber preform material F enclosed therein in particular is pressed against an uneven surface of the forming tool 10 forming an edge.

Due to the pressing, the fiber preform material F enclosed in the evacuable envelope 20 is forced to adopt the shape of the forming tool 10. The forming tool 10 and, therewith, the fiber preform material F enclosed in the envelope 20 is heated to a melting temperature of a binder or of a matrix contained in the fiber preform material F (being a dry fiber preform material or a pre-preg as mentioned above). Thereby, a cohesion of the fibers contained in the fiber preform material F is reduced. As a consequence, a (not shown) formation of the fibers in the fiber preform material F changes, whereby the fiber preform material F adjusts even further to the formable tool 10.

The air L₂ is then extracted from the envelope 20 which thus is evacuated, as depicted in FIG. 1c. Thereby, a clamping (compacting) force is applied to the fiber preform material F enclosed by the envelope 20.

When the bag 35 is thereafter unsealed, i.e., when air is allowed to enter the bag 35 as illustrated in FIG. 1d, the envelope 20 is maintained evacuated, such that the clamping/compaction is continued. Accordingly, a movement of the fibers within the fiber preform material's structure is inhibited or at least reduced. When the heating is stopped and the forming tool 10 as well as the fiber preform material F cool down, the shape of the fiber preform material F is thus maintained due to the ongoing application of the clamping force, even if a shrinkage S of the forming tool 10 occurs which due to unequal thermal expansion properties is different from a shrinkage of the fiber preform material. As a consequence, unfavorable deformations of the fiber preform material F such as undulations are obviated. In particular, the necessity of choosing materials for forming tool 10 and of the fiber preform material F which harmonize with regard to their thermal extension properties is relaxed such that materials having advantages with respect to other criteria (such as regarding the manufacture or availability) can be used while nevertheless fiber reinforced composite components of high quality can be produced.

Disclosed is a method which may serve to producing a fiber preform for a fiber reinforced composite component and/or to manufacturing the fiber reinforced composite component. The method comprises pressing an evacuable envelope 20 enclosing a fiber preform material F against a forming tool 10, the pressing being accomplished by evacuating an evacuable bag 35 containing the evacuable envelope 20 with the fiber preform material F. The method further comprises heating the forming tool 10 and/or the fiber preform material F, evacuating the envelope 20, and unsealing the bag 35 while maintaining the envelope 20 evacuated. Due to the maintained evacuated state, a clamping force acts on the fiber preform material which force serves to compensate different shrinkage of the forming tool and the fiber preform material when both cool down. It allows removing the evacuable envelope 20 with the fiber preform material at any temperature after forming.

Further disclosed is an assembly 1 which may serve to carry out the method.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCES

1 assembly
10 forming tool
20 envelope
30 bag component/membrane
35 bag
40 base
F fiber preform material
L₁ air in bag
L₂ air in envelope
P pressure force
S shrinkage

1. A method comprising:
pressing an evacuable envelope enclosing a fiber preform material against a forming tool by evacuating an evacuable bag containing the evacuable envelope with the fiber preform material;
heating the forming tool and/or the preform;
evacuating the envelope; and
unsealing the bag while maintaining the envelope evacuated.

2. The method according to claim 1, comprising inserting the fiber preform material into the envelope.

3. The method according to claim 1, wherein the evacuable bag is formed by a membrane in conjunction with the forming tool and/or with a base the forming tool is positioned on.

4. The method according to claim 1, wherein the evacuable bag is a receptacle containing, further to the envelope with the fiber preform, at least a portion of the forming tool.

5. The method according to claim 1, comprising letting the fiber preform material cool down, and unsealing the evacuated envelope after the fiber preform material has reached a temperature exceeding an ambient temperature by at most 80° C., at most 60° C., at most 40° C., or at most 20° C.

6. The method according to claim 1, comprising taking the evacuated envelope off the forming tool when a temperature of the forming tool exceeds an ambient temperature by at least 25° C., at least 50° C., or at least 80° C.

7. The method according to claim 1, wherein the fiber preform material is a dry fiber preform material or a pre-preg.

8. The method according to claim 1, wherein the fiber preform material is a dry fiber preform material, and the method comprises impregnating the fiber preform produced therefrom with a matrix.

9. The method according to claim 1, wherein the fiber preform material is a pre-preg, and heating the forming tool comprises heating the fiber preform to a curing temperature of the pre-preg.

10. An assembly comprising:
an envelope made of an air-tight material and configured to receive a fiber preform material;
a heatable forming tool for giving the fiber preform material a predetermined shape;
a bag component forming or configured to contribute to forming an evacuable bag configured to accommodate the envelope enclosing the fiber preform material; and
a device for evacuating the evacuable bag.
